(19) United States
(12) Patent Application Publication
(10) Pub. No.: US 2017/0339423 A1
(43) Pub. Date: Nov. 23, 2017

(54) IMAGE ENCODER USING SHARED MEAN VALUE CALCULATION CIRCUIT AND/OR SHARED CLIPPING CIRCUIT AND ASSOCIATED IMAGE ENCODING METHOD

(71) Applicant: MEDIATEK INC., Hsin-Chu (TW)

(72) Inventors: Li-Heng Chen, Tainan City (TW); Tung-Hsing Wu, Chiayi City (TW); Han-Liang Chou, Hsinchu County (TW)

(21) Appl. No.: 15/595,933

(22) Filed: May 15, 2017

Related U.S. Application Data
(60) Provisional application No. 62/340,011, filed on May 23, 2016.

(51) Int. Cl. H04N 19/50; H04N 19/70; H04N 19/436; H04N 19/124; H04N 19/103; H04N 19/184; H04N 19/176; H04N 19/182; H04N 19/186

(52) U.S. Cl. CPC H04N 19/50; H04N 19/124; H04N 19/70; H04N 19/436; H04N 19/103; H04N 19/176; H04N 19/182; H04N 19/186; H04N 19/184

(57) ABSTRACT

One exemplary image encoding method for encoding an image includes following steps: calculating a mean value of each color channel of a plurality of reconstructed pixels; determining a first predictor used by a first candidate coding mode of a current coding block according to mean values of color channels of the reconstructed pixels; determining a second predictor used by a second candidate coding mode of the current coding block according to the mean values of the color channels of the reconstructed pixels, wherein determining the first predictor and determining the second predictor are performed in a parallel manner; determining a coding mode selected from candidate coding modes including at least the first candidate coding mode and the second candidate coding mode; and encoding the current coding block into a part of a bitstream according to at least the determined coding mode.

### CROSS REFERENCE TO RELATED APPLICATIONS

This application claims the benefit of U.S. provisional application No. 62/340,011, filed on May 23, 2016 and incorporated herein by reference.

### BACKGROUND

The disclosed embodiments of the present invention relate to image encoding, and more particularly, to an image encoder using a shared mean value calculation circuit and/or a shared clipping circuit and an associated image encoding method.

A display interface is disposed between a first chip and a second chip to transmit display data from the first chip to the second chip for further processing. For example, the first chip may be a host application processor (AP), and the second chip may be a driver integrated circuit (IC). When a display panel supports a higher display resolution, 2D/3D display with higher resolution can be realized. Hence, the display data transmitted over the display interface would have a larger data size/data rate, which increases the power consumption of the display interface inevitably. If the host application processor and the driver IC are both located at the same portable device (e.g., smartphone) powered by a battery device, the battery life is shortened due to the increased power consumption of the display interface. Thus, there is a need for a data compression design which can effectively reduce the data size/data rate of the display data transmitted over the display interface as well as the power consumption of the display interface.

### SUMMARY

In accordance with exemplary embodiments of the present invention, an image encoder using a shared mean value calculation circuit and/or a shared clipping circuit and an associated image encoding method are proposed.

According to a first aspect of the present invention, an exemplary image encoding method for encoding an image is disclosed. The exemplary image encoding method includes: performing a mean value calculation operation to calculate a mean value of each color channel of a plurality of reconstructed pixels; determining a first predictor used by a first candidate coding mode of a current coding block according to a plurality of mean values of a plurality of color channels of the reconstructed pixels that are obtained by the mean value calculation operation, wherein the current coding block included in the image comprises a plurality of pixels; determining a second predictor used by a second candidate coding mode of the current coding block according to the mean values of the color channels of the reconstructed pixels that are obtained by the same mean value calculation operation, wherein determining the first predictor and determining the second predictor are performed in a parallel manner; determining a coding mode selected from a plurality of candidate coding modes of the current coding block, wherein the candidate coding modes comprise at least the first candidate coding mode and the second candidate coding mode; and encoding the current coding block into a part of a bitstream according to at least the determined coding mode.

According to a second aspect of the present invention, an exemplary image encoding method for encoding an image is disclosed. The exemplary image encoding method includes: performing a mean value calculation operation to calculate a mean value of each color channel of a plurality of reconstructed pixels; determining a first predictor used by a first candidate coding mode of a current coding block according to a plurality of mean values of a plurality of color channels of the reconstructed pixels that are obtained by the mean value calculation operation, wherein the current coding block included in the image comprises a plurality of pixels; determining a second predictor used by a second candidate coding mode of the current coding block according to the mean values of the color channels of the reconstructed pixels that are obtained by the same mean value calculation operation, wherein determining the second predictor is started after determining the first predictor is completed; determining a coding mode selected from a plurality of candidate coding modes of the current coding block, wherein the candidate coding modes comprise at least the first candidate coding mode and the second candidate coding mode; and encoding the current coding block into a part of a bitstream according to at least the determined coding mode.

According to a third aspect of the present invention, an exemplary image encoding method for encoding an image is disclosed. The exemplary image encoding method includes: performing a first mean value calculation operation to calculate a first mean value of each color channel of a plurality of first reconstructed pixels; determining a first predictor used by a first candidate coding mode of a current coding block according to a plurality of first mean values of a plurality of color channels of the first reconstructed pixels that are obtained by the first mean value calculation operation, wherein the current coding block included in the image comprises a plurality of pixels; performing a second mean value calculation operation to calculate a second mean value of each color channel of a plurality of second reconstructed pixels, wherein the second reconstructed pixels are same as or different from the first reconstructed pixels, and the first mean value calculation operation and the second mean value calculation operation are performed in a parallel manner; determining a second predictor used by a second candidate coding mode of the current coding block according to a plurality of second mean values of a plurality of color channels of the second reconstructed pixels that are obtained by the second mean value calculation operation, wherein determining the second predictor is started after determining the first predictor is completed; determining a coding mode selected from a plurality of candidate coding modes of the current coding block, wherein the candidate coding modes comprise at least the first candidate coding mode and the second candidate coding mode; and encoding the current coding block into a part of a bitstream according to at least the determined coding mode.

According to a fourth aspect of the present invention, an exemplary image encoder for encoding an image is disclosed. The exemplary image encoder includes a mode decision circuit and a compression circuit. The compression circuit includes a mean value calculation circuit, a first clipping circuit, and a second clipping circuit. The mean value calculation circuit is configured to perform a mean value calculation operation to calculate a mean value of each color channel of a plurality of reconstructed pixels. The first clipping circuit is configured to generate a first predictor used by a first candidate coding mode of a current coding block by clipping a plurality of mean values of a plurality of color channels of the reconstructed pixels that are obtained by the mean value calculation operation, wherein the current coding block included in the image comprises a plurality of pixels. The second clipping circuit is configured to generate a second predictor used by a second candidate coding mode of the current coding block by clipping the mean values of the color channels of the reconstructed pixels that are obtained by the same mean value calculation operation, wherein the first clipping circuit and the second clipping circuit are separate clipping circuits. The mode decision circuit is configured to determine a coding mode selected from a plurality of candidate coding modes of the current coding block, wherein the candidate coding modes comprise at least the first candidate coding mode and the second candidate coding mode. The compression circuit is further configured to encode the current coding block into a part of a bitstream according to at least the determined coding mode.

According to fifth aspect of the present invention, an exemplary image encoder for encoding an image is disclosed. The exemplary image encoder includes a mode decision circuit and a compression circuit. The compression circuit includes a mean value calculation circuit and a clipping circuit. The mean value calculation circuit is configured to perform a mean value calculation operation to calculate a mean value of each color channel of a plurality of reconstructed pixels. The clipping circuit is used to generate a first predictor used by a first candidate coding mode of a current coding block by clipping a plurality of mean values of a plurality of color channels of the reconstructed pixels that are obtained by the mean value calculation operation, and is reused to generate a second predictor used by a second candidate coding mode of the current coding block by clipping the mean values of the color channels of the reconstructed pixels that are obtained by the same mean value calculation operation, wherein the current coding block included in the image comprises a plurality of pixels. The mode decision circuit is configured to determine a coding mode selected from a plurality of candidate coding modes of the current coding block, wherein the candidate coding modes comprise at least the first candidate coding mode and the second candidate coding mode. The compression circuit is further configured to encode the current coding block into a part of a bitstream according to at least the determined coding mode.

According to a sixth aspect of the present invention, an exemplary image encoder for encoding an image is disclosed. The exemplary image encoder includes a mode decision circuit and a compression circuit. The compression circuit includes a first mean value calculation circuit, a second mean value calculation circuit, and a clipping circuit. The first mean value calculation circuit is configured to perform a first mean value calculation operation to calculate a first mean value of each color channel of a plurality of first reconstructed pixels. The second mean value calculation circuit is configured to perform a second mean value calculation operation to calculate a second mean value of each color channel of a plurality of second reconstructed pixels, wherein the second reconstructed pixels are same as or different from the first reconstructed pixels, and the first mean value calculation circuit and the second mean value calculation circuit are separate mean value calculation circuits. The clipping circuit is used to generate a first predictor used by a first candidate coding mode of a current coding block by clipping a plurality of first mean values of a plurality of color channels of the first reconstructed pixels that are obtained by the first mean value calculation operation, and is reused to generate a second predictor used by a second candidate coding mode of the current coding block by clipping a plurality of second mean values of a plurality of color channels of the second reconstructed pixels that are obtained by the second mean value calculation operation, wherein the current coding block included in the image comprises a plurality of pixels. The mode decision circuit is configured to determine a coding mode selected from a plurality of candidate coding modes of the current coding block, wherein the candidate coding modes comprise at least the first candidate coding mode and the second candidate coding mode. The compression circuit is further configured to encode the current coding block into a part of a bitstream according to at least the determined coding mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an image encoder according to an embodiment of the present invention.

FIG. 2 is a diagram illustrating a rate-distortion optimization based mode decision design employed by a mode decision circuit shown in FIG. 1 according to an embodiment of the present invention.

FIG. 3 is a flowchart illustrating a method of deriving a predictor for an MPP mode according to an embodiment of the present invention.

FIG. 4 is a diagram illustrating a previous pixel line used for midpoint value computation of a current coding block according to an embodiment of the present invention.

FIG. 5 is a diagram illustrating a previous coding block used for midpoint value computation of a current coding block according to an embodiment of the present invention.

FIG. 6 is a flowchart illustrating a method of determining a final predictor of MPP mode by applying a clipping function to an initial predictor of MPP mode according to an embodiment of the present invention.

FIG. 7 is a flowchart illustrating a method of deriving a predictor for an MPPF mode according to an embodiment of the present invention.

FIG. 8 is a flowchart illustrating a method of determining a final predictor of MPPF mode by applying a clipping function to an initial predictor of MPPF mode according to an embodiment of the present invention.

FIG. 9 is a diagram illustrating a first exemplary design of a part of a processing circuit in a compression circuit shown in FIG. 1 according to an embodiment of the present invention.

FIG. 10 is a diagram illustrating a second exemplary design of a part of a processing circuit in a compression circuit shown in FIG. 1 according to an embodiment of the present invention.

FIG. 11 is a diagram illustrating a third exemplary design of a part of a processing circuit in a compression circuit shown in FIG. 1 according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

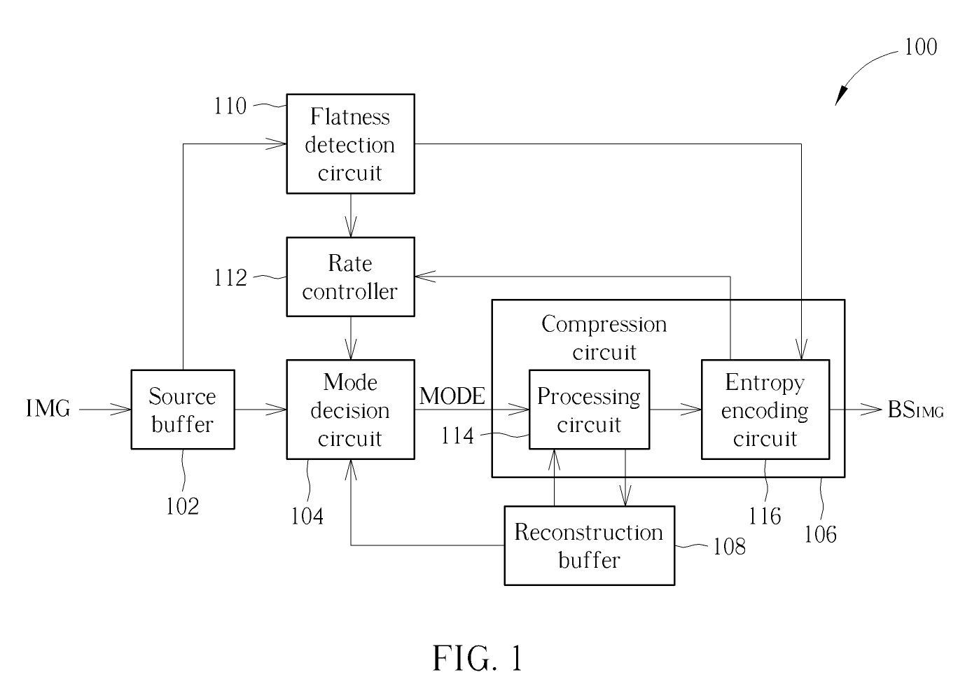

FIG. 1 is a block diagram illustrating an image encoder according to an embodiment of the present invention. In this embodiment, the image encoder 100 may be a Video Electronics Standards Association (VESA) Advanced Display Stream Compression (A-DSC) encoder. However, this is for illustrative purposes only, and is not meant to be a limitation of the present invention. In practice, any image encoder applying the proposed hardware sharing technique to computation of a midpoint-based predictor falls within the scope of the present invention. The image encoder 100 is used to encode/compress a source image IMG into a bitstream BS_{IMG}. In this embodiment, the image encoder 100 includes a source buffer 102, a mode decision circuit 104, a compression circuit 106, a reconstruction buffer 108, a flatness detection circuit 110, and a rate controller 112. The compression circuit 106 includes a processing circuit 114 and an entropy encoding circuit 116, where the processing circuit 114 is configured to perform several encoding functions, including prediction, quantization, reconstruction, etc. The source buffer 102 is configured to buffer raw pixel data of the source image IMG to be encoded/compressed. The flatness detection circuit 110 is configured to detect a transition from a non-flat area of the source image IMG to a flat area of the source image IMG. For example, the flatness detection circuit 110 classifies each coding block of the source image IMG to one of different flatness types based on the complexity estimation of previous, current and next coding blocks, where the flatness type affects the rate-control mechanism. Hence, the flatness detection circuit 110 generates a quantization parameter (QP) adjustment signal to the rate controller 112, and also outputs flatness indication to the entropy encoding circuit 116, such that the flatness type of each coding block is explicitly signaled to an image decoder (not shown) though the bitstream BS_{IMG}. The rate controller 112 is configured to adaptively control a quantization parameter used for encoding each coding block, such that the image quality can be maximized while a desired bit rate is ensured.

The source image IMG may be divided into a plurality of slices, wherein each of the slices may be independently encoded. In addition, each of the slices may have a plurality of coding blocks (or called coding units), each having a plurality of pixels. Each coding block (coding unit) is a basic compression unit. For example, each coding block (coding unit) may have 8×2 pixels according to VESA A-DSC, where 8 is the width of the coding block (coding unit), and 2 is the height of the coding block (coding unit). The mode decision circuit 104 is configured to determine a coding mode (e.g., best mode) MODE selected from a plurality of candidate coding modes for a current coding block (e.g., an 8×2 block) to be encoded. In accordance with VESA A-DSC, the candidate coding modes may be categorized into regular modes (e.g., transform mode, block prediction mode, pattern mode, delta pulse code modulation (DPCM) mode, and mid-point prediction (MPP) mode) and fallback modes (e.g., mid-point prediction fallback (MPPF) mode and “Blocker Predictor (BP) Skip” mode). For example, a rate-distortion (R-D) optimization technique may be employed for mode decision. The rate-distortion optimization mechanism is employed by the mode decision circuit 104 to select a coding mode with a smallest rate-distortion cost (R-D cost) as the best mode MODE for encoding the current coding block. In addition, the mode decision circuit 104 informs the processing circuit 114 of the best mode MODE, such that the compression circuit 106 is operative to encode the current coding block into the bitstream BS_{IMG} according to the best mode MODE.

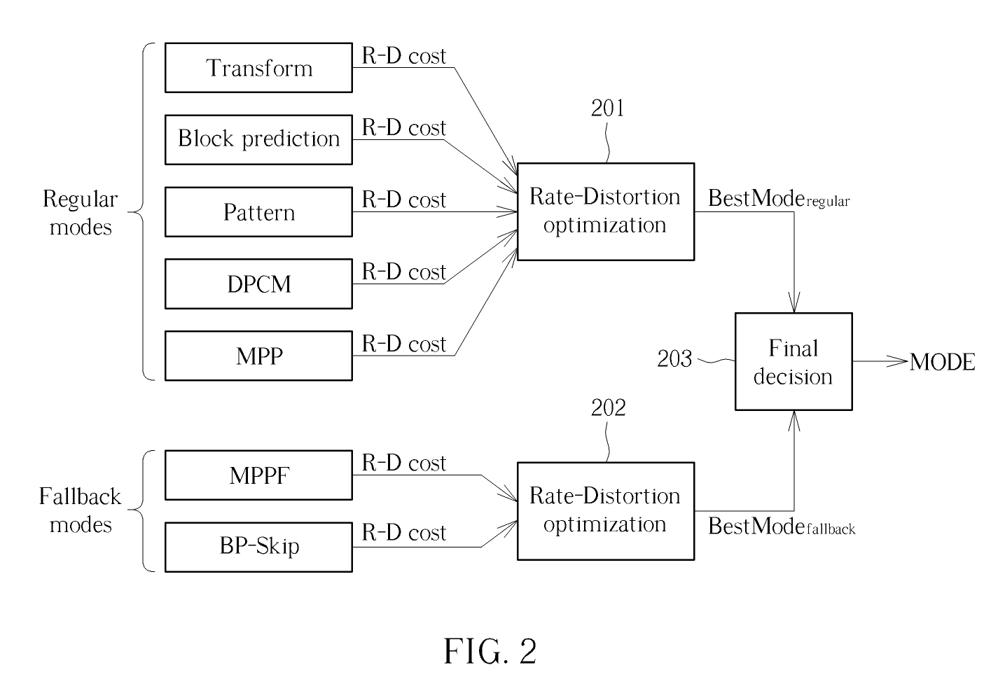

FIG. 2 is a diagram illustrating a rate-distortion optimization based mode decision design employed by the mode decision circuit 104 according to an embodiment of the present invention. Regarding each of the candidate coding modes, one rate-distortion cost (R-D cost) is evaluated. For example, a test encoding operation is applied to the current coding block under one candidate coding mode. In accordance with the test encoding operation, the amount of data required to encode the current coding block and the amount of distortion (e.g., difference between the current coding block and the associated reconstructed coding block) are used to determine the rate-distortion cost. Step 201 in FIG. 2 performs one rate-distortion optimization to select a best regular mode BestMode_{regular}. For example, a regular mode with a smallest rate-distortion cost among rate-distortion costs of all regular modes is selected as the best regular mode BestMode_{regular}. Step 202 in FIG. 2 performs another rate-distortion optimization to select a best fallback mode BestMode_{fallback}. For example, a fallback mode with a smallest rate-distortion cost among rate-distortion costs of all fallback modes is selected as the best fallback mode BestMode_{regular}. Step 203 in FIG. 2 receives the best regular mode BestMode_{regular} and the best fallback mode BestMode_{regular}, and makes a final decision which sets the best mode MODE for the current coding block (e.g., 8×2 block).

When the best mode MODE is an MPP mode or an MPPF mode, a predictor is calculated by the processing circuit 114, residuals of the current coding block are calculated by the processing circuit 114 through subtracting the predictor from each pixel of the current coding block (i.e., residual_{8×2}=source pixel_{8×2}-predictor), and the residuals of the current coding block are quantized by the processing circuit 114 through a quantizer.

The MPP mode uses the midpoint value as the predictor. The residuals of MPP mode are quantized by a simple power-of-2 quantizer. For each pixel, the k last significant bits are removed after the quantization process, where k is calculated by the quantization parameter (QP). The quantization process of MPP mode may be represented using the following formula.

$${RES}_{quantized} = \{ \begin{matrix}( res + round ) >> k , res > 0 \\ - ( ( round - res ) >> k ) , res \leq 0\end{matrix} \qquad ( 1 )$$

In above formula (1), the term “RES_{quantized}” represents the quantized residual, the term “res” represents the residual, and the term “round” represents the rounding value.

The MPPF mode is designed to guarantee the precise rate-control mechanism. Same as the MPP mode, the MPPF mode uses the midpoint value as the predictor. The residuals of MPPF mode are quantized by a one-bit quantizer. In other words, the quantized residuals are encoded using 1 bit per color channel sample. Hence, the quantized residuals of the current coding block (e.g., 8×2 block) have 48 bits, that is, 16 pixels*(1 bit/color channel)*(3 color channels/pixel).

Concerning the MPP/MPPF mode, the processing circuit 114 outputs quantized residuals of the current coding block to the entropy encoding circuit 116, and the entropy encoding circuit 116 encodes the quantized residuals of the current coding block into a part of the bitstream BS_{IMG}. In addition, the reconstruction buffer 108 is configured to store reconstructed pixels of some or all coding blocks in the source image IMG. For example, the processing circuit 114 performs inverse quantization upon the quantized residuals of the current coding block to generate inverse quantized residuals of the current coding block, and then adds a predictor to each of the inverse quantized residuals to generate one corresponding reconstructed pixel of the current coding block. Neighboring reconstructed pixels of the current coding block to be encoded may be read from the reconstruction buffer 108 for computing the predictor for the current coding block encoded using the MPP/MPPF mode.

As mentioned above, a test encoding operation is applied to the current coding block under a candidate coding mode for obtaining a rate-distortion cost of the candidate coding mode. For example, one test encoding operation is applied to the current coding block under an MPP mode (which is one candidate coding mode) for obtaining a rate-distortion cost of the MPP mode, and another test encoding operation is applied to the same current coding block under an MPPF mode (which is another candidate coding mode) for obtaining a rate-distortion cost of the MPPF mode. Regarding each of the MPP mode and the MPPF mode, a midpoint value is calculated to derive a predictor needed by the corresponding test encoding operation.

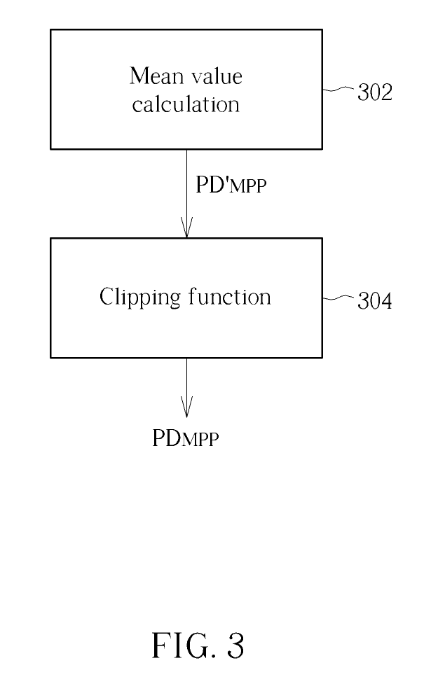

FIG. 3 is a flowchart illustrating a method of deriving a predictor for an MPP mode according to an embodiment of the present invention. At step 302, a mean value calculation operation is performed to compute midpoint values in color channels of a color space (e.g., RGB color space) to determine an initial predictor PD′_{MPP} in the color space (e.g., RGB color space) for a current coding block. The midpoint value is set by a fixed value (if neighboring reconstructed pixels needed for midpoint value computation of a current coding block are not available), or is computed from neighboring reconstructed pixels (if neighboring reconstructed pixels needed for midpoint value computation of the current coding block are available).

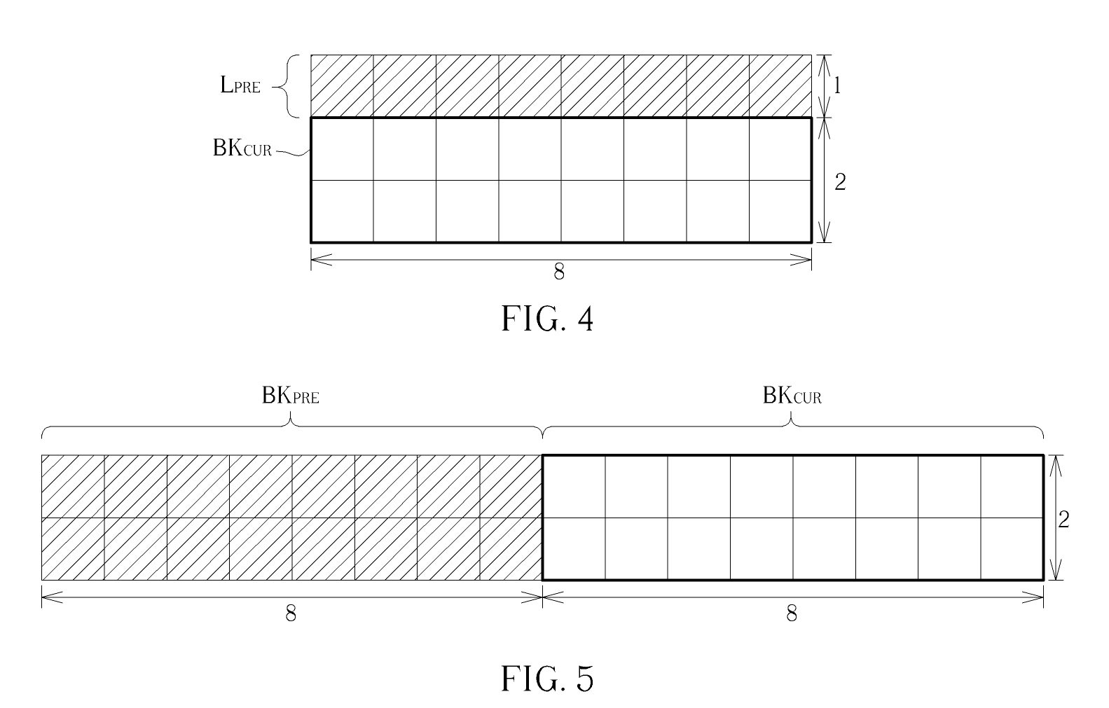

In a first exemplary design, neighboring reconstructed pixels needed for midpoint value computation of a current coding block are located at a previous pixel line, as illustrated in FIG. 4. The current coding block BK_{CUR} is an 8×2 block composed of 16 pixels, where 8 is the width of the current coding block BK_{CUR}, and 2 is the height of the current coding block BK_{CUR}. If the current coding block BK_{CUR} is a non-first-row block in the source image IMG, reconstructed pixels can be generated from reconstructing a plurality of pixels of a previous pixel line L_{PRE}, where the previous pixel line L_{PRE} is directly above an upper-most pixel line of the current coding block BK_{CUR}. Suppose that the reconstructed pixels are presented in the RGB color space. For each color channel (R, G, or B) of the RGB color space, a mean value (MP′_{R}, MP′_{G}, or MP′_{B}) of the reconstructed pixels of the previous pixel line L_{PRE} is calculated to act an initial predictor value in the color channel. For example, reconstructed pixel samples of the same color channel in the previous pixel line L_{PRE} are summed up, and then a summation result is divided by the number of the reconstructed pixel samples (i.e., 8×1) to generate the initial predictor value in the color channel. In this way, an initial predictor PD′_{MPP} composed of mean values MP′_{R}, MP′_{G}, MP′_{B} presented in the RGB color domain can be obtained for the current coding block BK_{CUR}.

However, if the current coding block BK_{CUR} is the first-row block in the source image IMG, this means reconstructed pixels at the previous pixel line L_{PRE} do not exist. Hence, a half value of the dynamic range of input pixels is directly used to set an initial predictor PD′_{MPP} of the current coding block BK_{CUR}. For an 8-bit input source, the initial predictor (MP′_{R}, MP′_{G}, MP′_{B}) of the current coding block BK_{CUR} is set by (128, 128, 128). For a 10-bit input source, the initial predictor (MP′_{R}, MP′_{G}, MP′_{B}) of the current coding block BK_{CUR} is set by (512, 512, 512).

In a second exemplary design, neighboring reconstructed pixels needed for midpoint value computation of a current coding block are located at a previous coding block, as illustrated in FIG. 5. The current coding block BK_{CUR} is an 8×2 block composed of 16 pixels, where 8 is the width of the current coding block BK_{CUR}, and 2 is the height of the current coding block BK_{CUR}. If the current coding block BK_{CUR} is not the first-column block in the source image IMG, reconstructed pixels can be generated from reconstructing a plurality of pixels of a previous coding block BK_{PRE} (which is also an 8×2 block composed of 16 pixels, where 8 is the width of the previous coding block BK_{PRE}, and 2 is the height of the previous coding block BK_{PRE}). The previous coding block BK_{PRE} is a left coding block of the current coding block BK_{CUR}. Suppose that the reconstructed pixels are presented in the RGB color space. For each color channel (R, G, or B) of the RGB color space, a mean value (MP′_{R}, MP′_{G}, or MP′_{B}) of the reconstructed pixels of the previous coding block BK_{PRE} is calculated to act an initial predictor value in the color channel. For example, reconstructed pixel samples of the same color channel in the previous coding block BK_{PRE} are summed up, and then a summation result is divided by the number of the reconstructed pixel samples to generate the initial predictor value in the color channel. In this way, an initial predictor PD′_{MPP} composed of mean values MP′_{R}, MP′_{G}, MP′_{B} presented in the RGB color domain can be obtained for the current coding block BK_{CUR}.

However, if the current coding block BK_{CUR} is the first-column block in the source image IMG, this means reconstructed pixels at the previous coding block BK_{PRE} do not exist. Hence, a half value of the dynamic range of input pixels is directly used to set an initial predictor PD′_{MPP} of the current coding block BK_{CUR}. For an 8-bit input source, the initial predictor (MP_{R}, MP_{G}, MP_{B}) of the current coding block BK_{CUR} is set by (128, 128, 128). For a 10-bit input source, the initial predictor (MP_{R}, MP_{G}, MP_{B}) of the current coding block BK_{CUR} is set by (512, 512, 512).

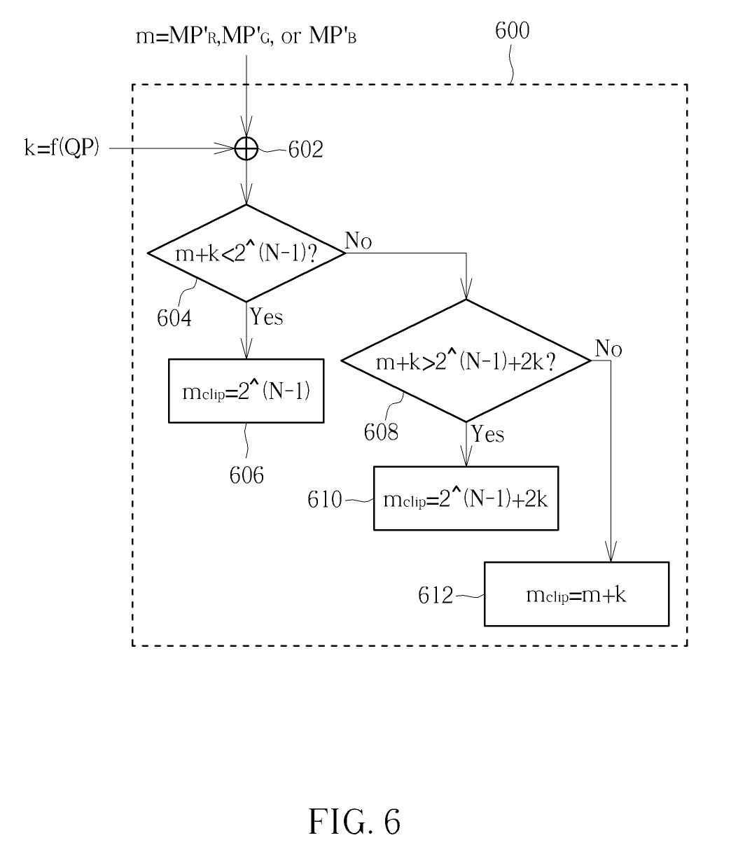

After the initial predictor PD′_{MPP} of the MPP mode is obtained, step 304 is performed to apply a clipping function to the initial predictor PD′_{MPP} for determining a final predictor PD_{MPP} of the MPP mode. FIG. 6 is a flowchart illustrating a method of determining the final predictor PD_{MPP} of the MPP mode by applying a clipping function 600 to the initial predictor PD′_{MPP} of the MPP mode according to an embodiment of the present invention. In this embodiment, the clipping function 600 may include steps 602, 604, 606, 608, 610, and 612. The same clipping function 600 is applied to a mean value (MP′_{R}, MP′_{G}, or MP′_{B}) of each color channel (R, G, or B). Hence, the mean value m to be processed by the clipping function 600 is set by one of mean values MP′_{R}, MP′_{G}, MP′_{B} of the initial predictor PD′_{MPP}. In addition, a bias value k used by the clipping function 600 is derived from a quantization parameter (QP) assigned to the current coding block. That is, k=f(QP), where f( ) is a function of setting the bias value k for MPP mode.

At step 602, the bias value k (k=f(QP)) is added to the mean value m (m=MP′_{R}, MP′_{G}, or MP′_{B}) to generate a biased mean value m+k. At step 604, the biased mean value m+k is compared with 2̂(N−1) to check if the biased mean value m+k is smaller than 2̂(N−1), where N is a bit depth of each pixel included in the current coding block. For an 8-bit input source, N=8 and 2̂(N−1)=128. For a 10-bit input source, N=10 and 2̂(N−1)=512. When the biased mean value m+k is smaller than 2̂(N−1), a clipped mean value m_{clip} generated from the clipping function 600 is set by 2̂(N−1). In other words, the mean value m (m=MP′_{R}, MP′_{G}, or MP′_{B}) is clipped at 2̂(N−1) when m+k<2̂(N−1). However, when the biased mean value m+k is not smaller than 2̂(N−1), step 608 is performed to compare the biased mean value m+k with 2̂(N−1)+2k to check if the biased mean value m+k is larger than 2̂(N−1)+2k. When the biased mean value m+k is larger than 2̂(N−1)+2k, the clipped mean value m_{clip} generated from the clipping function 600 is set by 2̂(N−1)+2k. In other words, the mean value m (m=MP′_{R}, MP′_{G}, or MP′_{B}) is clipped at 2̂(N−1)+2k when m+k>2̂(N−1)+2k. However, when the biased mean value m+k is not larger than 2̂(N−1)+2k, the clipped mean value m_{clip} generated from the clipping function 600 is set by m+k. In other words, the mean value m (m=MP′_{R}, MP′_{G}, or MP′_{B}) is clipped at m+k when m+k≦2̂(N−1)+2k.

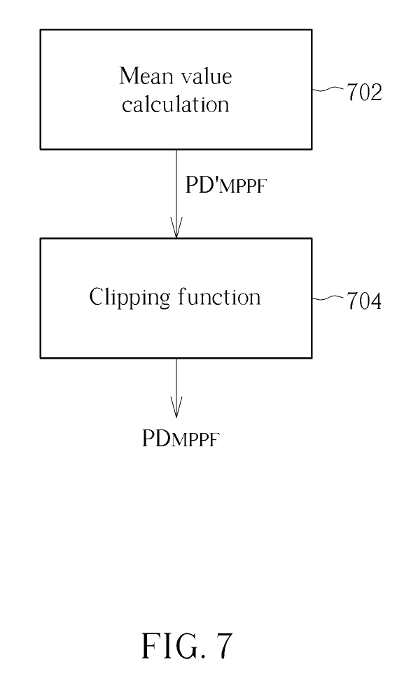

FIG. 7 is a flowchart illustrating a method of deriving a predictor for an MPPF mode according to an embodiment of the present invention. Like the MPP mode, the MPPF mode also uses the midpoint value to derive a predictor used for calculating residuals of a coding block. At step 702, a mean value calculation operation is performed to compute a midpoint value in each color channel of a color space (e.g., RGB color space) to determine an initial predictor PD′_{MPPF} in the color space (e.g., RGB color space) for a current coding block. The midpoint value is set by a fixed value (if neighboring reconstructed pixels needed for midpoint value computation of a current coding block are not available), or is computed from neighboring reconstructed pixels (if neighboring reconstructed pixels needed for midpoint value computation of the current coding block are available).

In a first exemplary design, neighboring reconstructed pixels needed for midpoint value computation of a current coding block are located at a previous pixel line, as illustrated in FIG. 4. The current coding block BK_{CUR} is an 8×2 block composed of 16 pixels, where 8 is the width of the current coding block BK_{CUR}, and 2 is the height of the current coding block BK_{CUR}. If the current coding block BK_{CUR} is a non-first-row block in the source image IMG, reconstructed pixels can be generated from reconstructing a plurality of pixels of a previous pixel line L_{PRE}, where the previous pixel line L_{PRE} is directly above an upper-most pixel line of the current coding block BK_{CUR}. Suppose that the reconstructed pixels are presented in the RGB color space. For each color channel (R, G, or B) of the RGB color space, a mean value (mp′_{R}, mp′_{G}, or mp′_{B}) of the reconstructed pixels of the previous pixel line L_{PRE} is calculated to act an initial predictor value in the color channel. For example, reconstructed pixel samples of the same color channel in the previous pixel line L_{PRE} are summed up, and then a summation result is divided by the number of the reconstructed pixel samples to generate the initial predictor value in the color channel. In this way, an initial predictor PD′_{MPPF} composed of mean values mp′_{R}, mp′_{G}, mp′_{B} presented in the RGB color domain can be obtained for the current coding block BK_{CUR}.

However, if the current coding block BK_{CUR} is the first-row block in the source image IMG, this means reconstructed pixels at the previous pixel line L_{PRE} do not exist. Hence, a half value of the dynamic range of input pixels is directly used to set an initial predictor PD′_{MPPF} of the current coding block BK_{CUR}. For an 8-bit input source, the initial predictor (mp′_{R}, mp′_{G}, mp′_{B}) of the current coding block BK_{CUR} is set by (128, 128, 128). For a 10-bit input source, the initial predictor (mp′_{R}, mp′_{G}, mp′_{B}) of the current coding block BK_{CUR} is set by (512, 512, 512).

In a second exemplary design, neighboring reconstructed pixels needed for midpoint value computation of a current coding block are located at a previous coding block, as illustrated in FIG. 5. The current coding block BK_{CUR} is an 8×2 block composed of 16 pixels, where 8 is the width of the current coding block BK_{CUR}, and 2 is the height of the current coding block BK_{CUR}. If the current coding block BK_{CUR} is not the first-column block in the source image IMG, reconstructed pixels can be generated from reconstructing a plurality of pixels of a previous coding block BK_{PRE} (which is also an 8×2 block composed, of 16 pixels, where 8 is the width of the previous coding block BK_{PRE}, and 2 is the height of the previous coding block BK_{PRE}). The previous coding block BK_{PRE} is a left coding block of the current coding block BK_{CUR}. Suppose that the reconstructed pixels are presented in the RGB color space. For each color channel (R, G, or B) of the RGB color space, a mean value (mp′_{R}, mp′_{G}, or mp′_{B}) of the reconstructed pixels of the previous coding block BK_{PRE} is calculated to act an initial predictor value in the color channel. For example, reconstructed pixels samples of the same color channel in the previous coding block BK_{PRE} are summed up, and then a summation result is divided by the number of the reconstructed pixel samples to generate the initial predictor value in the color channel. In this way, an initial predictor PD′_{MPPF} composed of mean values mp′_{R}, mp′_{G}, mp′_{B} presented in the RGB color domain can be obtained for the current coding block BK_{CUR}.

However, if the current coding block BK_{CUR} is the first-column block in the source image IMG, this means reconstructed pixels at the previous coding block BK_{PRE} do not exist. Hence, a half value of the dynamic range of input pixels is directly used to set an initial predictor PD′_{MPPF} of the current coding block BK_{CUR}. For an 8-bit input source, the initial predictor (mp_{R}, mp_{G}, mp_{B}) of the current coding block BK_{CUR} is set by (128, 128, 128). For a 10-bit input source, the initial predictor (mp_{R}, mp_{G}, mp_{B}) of the current coding block BK_{CUR} is set by (512, 512, 512).

After the initial predictor PD′_{MPPF} of the MPPF mode is obtained, step 704 is performed to apply a clipping function to the initial predictor PD′_{MPPF} for determining a final predictor PD_{MPPF} of the MPPF mode. In one exemplary design, the initial predictor PD′_{MPP} of the MPP mode and the initial predictor PD′_{MPPF} of the MPPF mode may processed by the same the clipping function with different bias value settings.

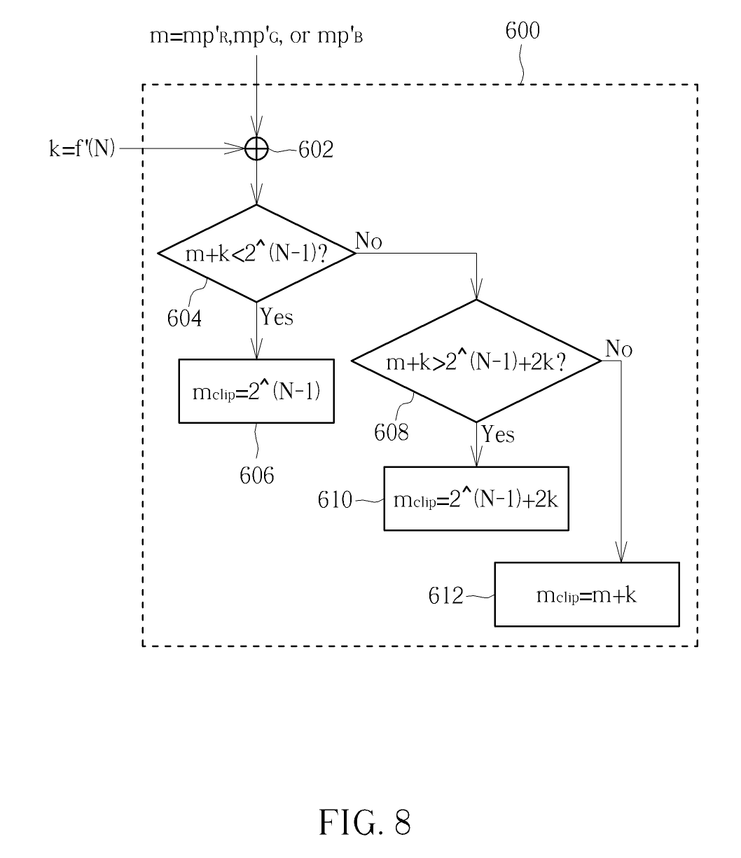

FIG. 8 is a flowchart illustrating a method of determining the final predictor PD_{MPPF} of the MPPF mode by applying the clipping function 600 to the initial predictor PD′_{MPPF} of the MPPF mode according to an embodiment of the present invention. The clipping function 600 shown in FIG. 8 is same as the clipping function 600 shown in FIG. 6. Similarly, the same clipping function 600 is applied to a mean value (mp′_{R}, mp′_{G}, or mp′_{B}) of each color channel (R, G, or B). Hence, the mean value m to be processed by the clipping function 600 is set by one of mean values mp′_{R}, mp′_{G}, mp′_{B} of the initial predictor PD′_{MPPF}. It should be noted that, if reconstructed pixels used for computing the initial predictor PD′_{MPPF} (which is composed of mean values mp′_{R}, mp′_{G}, mp′_{B}) of the current coding block are same as reconstructed pixels used for computing the initial predictor PD′_{MPP} (which is composed of mean values MP′_{R}, MP′_{G}, MP′_{B}) of the current coding block, mean values mp′_{R}, mp′_{G}, mp′_{B} are same as mean values MP′_{R}, MP′_{G}, MP′_{B}, respectively. That is, MP′_{R}=mp′_{R}, MP′_{G}=mp′_{G}, and MP′_{B}=mp′_{B}. However, this is for illustrative purposes only, and is not meant to be a limitation of the present invention. Alternatively, if reconstructed pixels used for computing the initial predictor PD′_{MPPF} (which is composed of mean values mp′_{R}, mp′_{G}, mp′_{B}) of the current coding block are different from reconstructed pixels used for computing the initial predictor PD′_{MPP} (which is composed of MP′_{R}, MP′_{G}, MP′_{B}) of the current coding block, mean values mp′_{R}, mp′_{G}, mp′_{B} are not necessarily same as mean values MP′_{R}, MP′_{G}, MP′_{B}, respectively.

The bias value k used by the clipping function 600 applied to the initial predictor PD′_{MPP} of MPP mode and the bias value k used by the clipping function 600 applied to the initial predictor PD′_{MPPF} of MPPF mode are derived from different data, respectively. For example, the bias value k used by the clipping function 600 applied to the initial predictor PD′_{MPPF} of MPPF mode is derived from the bit depth N of each pixel included in the current coding block. That is, k=f′(N), where f′( ) is a function of setting the bias value k for MPPF mode. It should be noted that the function f( ) of setting the bias value k for MPP mode and the function f′( ) of setting the bias value k for MPPF mode may be same or different, depending upon actual design consideration.

At step 602 in FIG. 8, the bias value k (k=f′(N)) is added to the mean value m (m=mp′_{R}, mp′_{G}, or mp′_{B}) to generate a biased mean value m+k. At step 604 in FIG. 8, the biased mean value m+k is compared with 2̂(N−1) to check if the biased mean value m+k is smaller than 2̂(N−1), where N is the bit depth of each pixel included in the current coding block. For an 8-bit input source, N=8 and 2̂(N−1)=128. For a 10-bit input source, N=10 and 2̂(N−1)=512. When the biased mean value m+k is smaller than 2̂(N−1), a clipped mean value m_{clip} generated from the clipping function 600 is set by 2̂(N−1). In other words, the mean value m (m=mp′_{R}, mp′_{G}, or mp′_{B}) is clipped at 2̂(N−1) when m+k<2̂(N−1). However, when the biased mean value m+k is not smaller than 2̂(N−1), step 608 in FIG. 8 is performed to compare the biased mean value m+k with 2̂(N−1)+2k to check if the biased mean value m+k is larger than 2̂(N−1)+2k. When the biased mean value m+k is larger than 2̂(N−1)+2k, the clipped mean value m_{clip} generated from the clipping function 600 is set by 2̂(N−1)+2k. In other words, the mean value m (m=mp′_{R}, mp′_{G}, or mp′_{B}) is clipped at 2̂(N−1)+2k when m+k>2̂(N−1)+2k. However, when the biased mean value m+k is not larger than 2̂(N−1)+2k, the clipped mean value m_{clip} generated from the clipping function 600 is set by m+k. In other words, the mean value m (m=mp′_{R}, mp′_{G}, or mp′_{B}) is clipped at m+k when m+k≦2̂(N−1)+2k.

If predictor computation of MPP mode and predictor computation of MPPF mode are separately performed on different hardware circuits (e.g., steps 302 and 702 are performed using separate hardware circuits, and/or steps 304 and 704 are performed using separate hardware circuits), the hardware cost is inevitably high. To solve this hardware cost issue, the present invention therefore proposes using a hardware sharing technique in a hardware circuit design, thereby reducing the hardware cost. Further details are described as below.

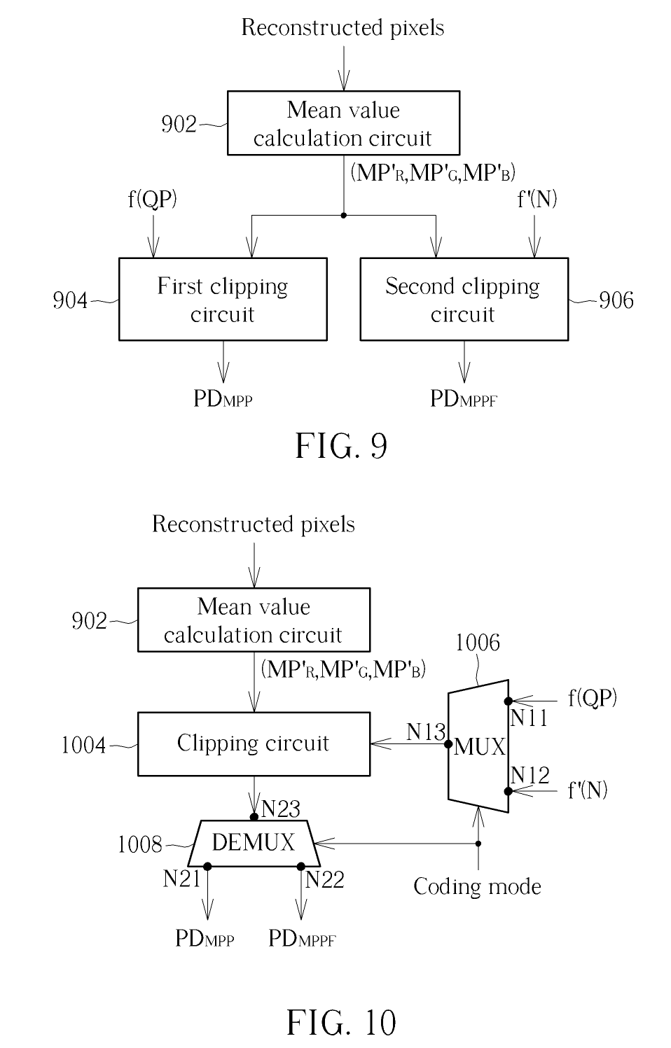

FIG. 9 is a diagram illustrating a first exemplary design of a part of the processing circuit 114 in the compression circuit 106 according to an embodiment of the present invention. With regard to derivation of the final predictor PD_{MPP} for MPP mode and derivation of the final predictor PD_{MPPF} for MPPF mode, the processing circuit 114 may be configured to include a mean value calculation circuit 902 and a plurality of separate clipping circuits (e.g., a first clipping circuit 904 and a second clipping circuit 906). The mean value calculation circuit 902 is configured to perform a mean value calculation operation to calculate a mean value of each color channel of a plurality of reconstructed pixels. Assuming that the color space is an RGB color space and the candidate coding modes are MPP mode and MPPF mode, mean values MP′_{R}, MP′_{G}, MP′_{B} are generated from the mean value calculation circuit 902. In this embodiment, reconstructed pixels used for computing the initial predictor PD′_{MPPF} (which is composed of mean values mp′_{R}, mp′_{G}, mp′_{B}) of the current coding block are same as reconstructed pixels used for computing the initial predictor PD′_{MPP} (which is composed of mean values MP′_{R}, MP′_{G}, MP′_{B}) of the current coding block. For example, an initial predictor PD′_{MPP} of the current coding block BK_{CUR} is set by mean values MP′_{R}, MP′_{G}, MP′_{B} of different color channels of the previous pixel line L_{PRE} as shown in FIG. 4, and an initial predictor PD′_{MPPF} of the same current coding block BK_{CUR} is also set by the mean values MP′_{R}, MP′_{G}, MP′_{B} of different color channels of the same previous pixel line L_{PRE} as shown in FIG. 4, where mp′_{R}=MP′_{R}, mp′_{G}=MP′_{G}, and mp′_{B}=MP′_{B}. For another example, an initial predictor PD′_{MPP} of the current coding block BK_{CUR} is set by mean values MP′_{R}, MP′_{G}, MP′_{B} of different color channels of the previous coding block BK_{PRE} as shown in FIG. 5, and an initial predictor PD′_{MPPF} of the same current coding block BK_{CUR} is also set by the mean values MP′_{R}, MP′_{G}, MP′_{B} of different color channels of the same previous coding block BK_{PRE} as shown in FIG. 5, where mp′_{R}=MP′_{R}, mp′_{G}=MP′_{G}, and mp′_{B}=MP′_{B}. In other words, step 302 shown in FIG. 3 and step 702 shown in FIG. 7 are merged into a single mean value calculation operation that is performed by the mean value calculation circuit 902 only once. In this way, the mean value calculation circuit 902 outputs mean values MP′_{R}, MP′_{G}, MP′_{B} to serve as an initial predictor PD′_{MPP} of the current coding block as well as an initial predictor PD′_{MPPF} of the same current coding block.

The first clipping circuit 904 is configured to generate a first predictor used by a first candidate coding mode (e.g., final predictor PD_{MPP} for MPP mode) by applying a clipping function (e.g., clipping function 600 shown in FIG. 6) with a first bias value f(QP) to mean values MP′_{R}, MP′_{G}, MP′_{B} of color channels (R, G, B) that are obtained by the mean value calculation operation performed by the mean value calculation circuit 902.

The second clipping circuit 906 is configured to generate a second predictor used by a second candidate coding mode (e.g., final predictor PD_{MPPF} for MPPF mode) by applying the same clipping function (e.g., clipping function 600 shown in FIG. 8) with a second bias value f′(N) to mean values MP′_{R}, MP′_{G}, MP′_{B} of color channels (R, G, B) that are obtained by the same mean value calculation operation performed by the mean value calculation circuit 902.

The same mean values MP′_{R}, MP′_{G}, MP′_{B} generated from the mean value calculation circuit 902 are shared by the first clipping circuit 904 and the second clipping circuit 906. Hence, the hardware cost associated with the mean value calculation for MPP mode and MPPF mode can be reduced due to the use of the shared mean value calculation circuit 902.

In this embodiment, the first clipping circuit 904 and the second clipping circuit 906 may be configured to operate in parallel, such that the operation of determining the first predictor (e.g., final predictor PD_{MPP} for MPP mode) and the operation of determining the second predictor (e.g., final predictor PD_{MPPF} for MPPF mode) may be performed in a parallel manner. For example, the first predictor (e.g., final predictor PD_{MPP} for MPP mode) is generated by the first clipping circuit 904 that is configured to perform the clipping function with the first bias value f(QP) during a first period, and the second predictor (e.g., final predictor PD_{MPPF} for MPPF mode) is generated by the second clipping circuit 906 that is configured to perform the same clipping function with the second bias value f′(N) during a second period overlapping the first period. However, this is for illustrative purposes only, and is not meant to be a limitation of the present invention.

FIG. 10 is a diagram illustrating a second exemplary design of a part of the processing circuit 114 in the compression circuit 106 according to an embodiment of the present invention. With regard to derivation of the final predictor PD_{MPP} for MPP mode and derivation of the final predictor PD_{MPPF} for MPPF mode, the processing circuit 114 may be configured to include a clipping circuit 1004, a multiplexer (MUX) 1006, a demultiplexer (DEMUX) 1008, and the aforementioned mean value calculation circuit 902. The mean value calculation circuit 902 is configured to perform a mean value calculation operation to calculate a mean value of each color channel of a plurality of reconstructed pixels. Assuming that the color space is an RGB color space and the candidate coding modes are MPP mode and MPPF mode, mean values MP′_{R}, MP′_{G}, MP′_{B} are generated from the mean value calculation circuit 902. In this embodiment, reconstructed pixels used for computing the initial predictor PD′_{MPPF} (mp′_{R}, mp′_{G}, mp′_{B}) of the current coding block are same as reconstructed pixels used for computing the initial predictor PD′_{MPP} (MP′_{R}, MP′_{G}, MP′_{B}) of the current coding block. Hence, step 302 shown in FIG. 3 and step 702 shown in FIG. 7 are merged into a single mean value calculation operation that is performed by the mean value calculation circuit 902 only once. In this way, the mean value calculation circuit 902 outputs mean values MP′_{R}, MP′_{G}, MP′_{B} to serve as an initial predictor PD′_{MPP} of the current coding block as well as an initial predictor PD′_{MPPF} of the same current coding block.

As mentioned above, the same clipping function (e.g., clipping function 600 shown in FIG. 6 and FIG. 8) is involved in computation of the final predictor PD_{MPP} for MPP mode and computation of the final predictor PD_{MPPF} for MPPF mode. Based on this observation, the present invention proposes using a shared clipping circuit to deal with computation of the final predictor PD_{MPP} for MPP mode and computation of the final predictor PD_{MPPF} for MPPF mode in a sequential manner. The multiplexer 1006 includes two input ports N11, N12 and one output port N13. The demultiplexer 1008 includes two output ports N21, N22 and one input port N23. The multiplexer 1006 and the demultiplexer 1008 are controlled by a coding mode currently being processed.

In one exemplary design, the clipping circuit 1004 is used to deal with computation of the final predictor PD_{MPP} of a coding block, and then is reused to deal with computation of the final predictor PD_{MPPF} of the same coding block. When the coding mode is MPP mode, the multiplexer 1006 is controlled to connect the input port N11 to the output port N13, and the demultiplexer 1008 is controlled to connect the input port N23 to the output port N21. Hence, the first bias value f(QP) needed by a clipping function (e.g., clipping function 600 shown in FIG. 6) is fed into the clipping circuit 1004 via the multiplexer 1006. The final predictor PD_{MPP} is generated by the clipping circuit 1004 that is used to perform the clipping function (e.g., clipping function 600 shown in FIG. 6) with the first bias value f(QP) during a first period, and is output via the demultiplexer 1008. When the coding mode is MPPF mode, the multiplexer 1006 is controlled to connect the input port N12 to the output port N13, and the demultiplexer 1008 is controlled to connect the input port N23 to the output port N22. Hence, the second bias value f′(N) needed by the clipping function (e.g., clipping function 600 shown in FIG. 8) is fed into the clipping circuit 1004 via the multiplexer 1006. The final predictor PD_{MPPF} is generated by the clipping circuit 1004 that is reused to perform the clipping function (e.g., clipping function 600 shown in FIG. 8) with the second bias value f′(N) during a second period not overlapping the first period, and is output via the demultiplexer 1008.

In another exemplary design, the clipping circuit 1004 is used to deal with computation of the final predictor PD_{MPPF} of a coding block, and then is reused to deal with computation of the final predictor PD_{MPP} of the same coding block. When the coding mode is MPPF mode, the multiplexer 1006 is controlled to connect the input port N12 to the output port N13, and the demultiplexer 1008 is controlled to connect the input port N23 to the output port N22. Hence, the second bias value f′(N) needed by a clipping function (e.g., clipping function 600 shown in FIG. 8) is fed into the clipping circuit 1004 via the multiplexer 1006. The final predictor PD_{MPPF} is generated by the clipping circuit 1004 that is used to perform the clipping function (e.g., clipping function 600 shown in FIG. 8) with the second bias value f′(N) during a first period, and is output via the demultiplexer 1008. When the coding mode is MPP mode, the multiplexer 1006 is controlled to connect the input port N11 to the output port N13, and the demultiplexer 1008 is controlled to connect the input port N23 to the output port N21. Hence, the first bias value f(QP) needed by the clipping function (e.g., clipping function 600 shown in FIG. 6) is fed into the clipping circuit 1004 via the multiplexer 1006. The final predictor PD_{MPP} is generated by the clipping circuit 1004 that is reused to perform the clipping function (e.g., clipping function 600 shown in FIG. 6) with the first bias value f(QP) during a second period not overlapping the first period, and is output via the demultiplexer 1008.

The same mean values MP′_{R}, MP′_{G}, MP′_{B} generated from the mean value calculation circuit 902 are shared by following computation of the final predictor PD_{MPP} for MPP mode and following computation of the final predictor PD_{MPPF} for MPPF mode. Hence, the hardware cost associated with the mean value calculation for MPP mode and MPPF mode can be reduced due to the use of the shared mean value calculation circuit 902. In addition, the same clipping circuit 1004 can be used to deal with computation of the final predictor PD_{MPP} for MPP mode and computation of the final predictor PD_{MPPF} for MPPF mode in a sequential manner. Hence, the hardware cost associated with the clipping operation for MPP mode and MPPF mode can be reduced due to the use of the shared clipping circuit 1004.

In the embodiment shown in FIG. 10, one shared mean value calculation circuit and one shared clipping circuit are both used to achieve hardware cost reduction. However, this is for illustrative purposes only, and is not meant to be a limitation of the present invention. In practice, any computation hardware design using the shared clipping circuit for deriving a midpoint-based predictor can achieve the same objective of reducing the hardware cost, and also falls within the scope of the present invention.

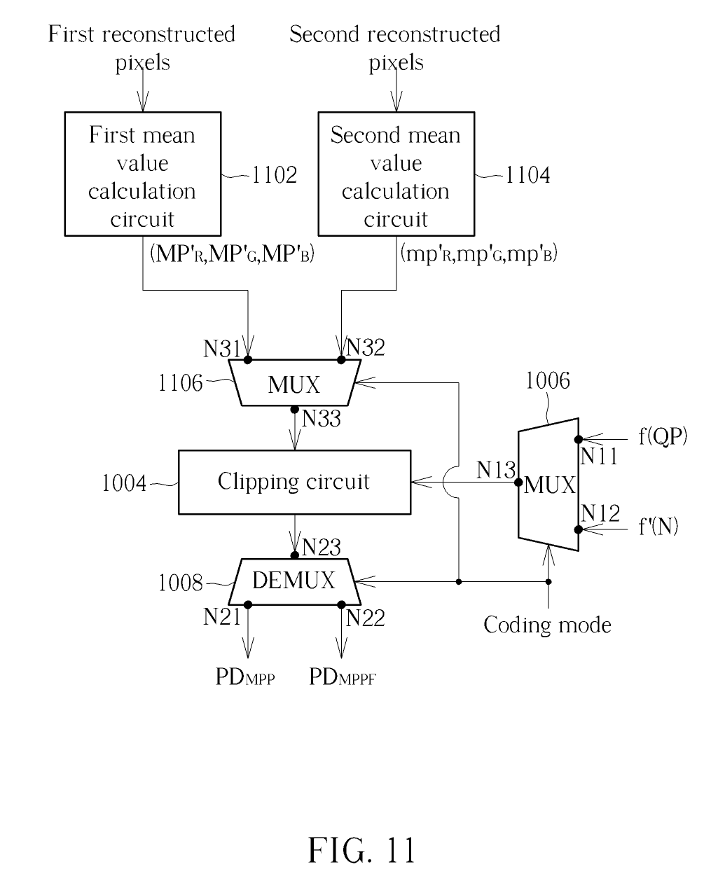

FIG. 11 is a diagram illustrating a third exemplary design of a part of the processing circuit 114 in the compression circuit 106 according to an embodiment of the present invention. With regard to derivation of the final predictor PD_{MPP} for MPP mode and derivation of the final predictor PD_{MPPF} for MPPF mode, the processing circuit 114 may be configured to include a plurality of separate mean value calculation circuits (e.g., a first mean value calculation circuit 1102 and a second mean value calculation circuit 1104), a multiplexer (MUX) 1106, and the aforementioned clipping circuit 1004, multiplexer (MUX) 1006 and demultiplexer (DEMUX) 1008. The first mean value calculation circuit 1102 is configured to perform a first mean value calculation operation to calculate a first mean value of each color channel of a plurality of first reconstructed pixels. The second mean value calculation circuit 1104 is configured to perform a second mean value calculation operation to calculate a second mean value of each color channel of a plurality of second reconstructed pixels. Assuming that the color space is an RGB color space and the candidate coding modes are MPP mode and MPPF mode, mean values MP′_{R}, MP′_{G}, MP′_{B} are generated from the first mean value calculation circuit 1102, and mean values mp′_{R}, mp′_{G}, mp′_{B} are generated from the second mean value calculation circuit 1104. The mean values MP′_{R}, MP′_{G}, MP′_{B} are used to serve as an initial predictor PD′_{MPP} of a current coding block under MPP mode, and the mean values mp′_{R}, mp′_{G}, mp′_{B} are used to serve as an initial predictor PD′_{MPPF} of the same current coding block under MPPF mode. In a case where the second reconstructed pixels are same as the first reconstructed pixels, mean values mp′_{R}, mp′_{G}, mp′_{B} are same as mean values MP′_{R}, MP′_{G}, MP′_{B}, respectively. In another case where the second reconstructed pixels are different from the first reconstructed pixels, mean values mp′_{R}, mp′_{G}, mp′_{B} are not necessarily same as mean values MP′_{R}, MP′_{G}, MP′_{B}, respectively.

In this embodiment, the first mean value calculation circuit 1102 and the second mean value calculation circuit 1104 may be configured to operate in parallel, such that the first mean value calculation operation (e.g., computation of initial predictor PD′_{MPP} for MPP mode) and the second mean value calculation operation (e.g., computation of initial predictor PD′_{MPPF} for MPPF mode) may be performed in a parallel manner. For example, the mean values MP′_{R}, MP′_{G}, MP′_{B} are generated by the first mean value calculation circuit 1102 that is configured to perform the first mean value calculation operation during a first period, and the mean values mp′_{R}, mp′_{G}, mp′_{B} are generated by the second mean value calculation circuit 1104 that is configured to perform the second mean value calculation operation during a second period overlapping the first period.

The multiplexer 1106 includes two input ports N31, N32 and one output port N33. Since the clipping circuit 1004 is shared between computation of the final predictor PD_{MPP} for MPP mode and computation of the final predictor PD_{MPPF} for MPPF mode, the multiplexer 1106 is controlled to selectively output mean values MP′_{R}, MP′_{G}, MP′_{B} or mean values mp′_{R}, mp′_{G}, mp′_{B} to the clipping circuit 1004. Byway of example, but not limitation, the mean values MP′_{R}, MP′_{G}, MP′_{B} may be buffered in the first mean value calculation circuit 1102 before transmitted to the clipping circuit 1004 via the multiplexer 1106, and the mean values mp′_{R}, mp′_{G}, mp′_{B} may be buffered in the second mean value calculation circuit 1102 before transmitted to the clipping circuit 1004 via the multiplexer 1106. In this embodiment, the multiplexers 1006, 1106 and the demultiplexer 1008 are controlled by a coding mode currently being processed.

In one exemplary design, the clipping circuit 1004 is used to deal with computation of the final predictor PD_{MPP} of a coding block, and then is reused to deal with computation of the final predictor PD_{MPPF} of the same coding block. When the coding mode is MPP mode, the multiplexer 1106 is controlled to connect the input port N31 to the output port N33, the multiplexer 1006 is controlled to connect the input port N11 to the output port N13, and the demultiplexer 1008 is controlled to connect the input port N23 to the output port N21. Hence, the first bias value f(QP) needed by a clipping function (e.g., clipping function 600 shown in FIG. 6) is fed into the clipping circuit 1004 via the multiplexer 1006, and the mean values MP′_{R}, MP′_{G}, MP′_{B} to be processed by the clipping function (e.g., clipping function 600 shown in FIG. 6) are fed into the clipping circuit 1004 via the multiplexer 1106. The final predictor PD_{MPP} is generated by the clipping circuit 1004, and is output via the demultiplexer 1008. When the coding mode is MPPF mode, the multiplexer 1106 is controlled to connect the input port N32 to the output port N33, the multiplexer 1006 is controlled to connect the input port N12 to the output port N13, and the demultiplexer 1008 is controlled to connect the input port N23 to the output port N22. Hence, the second bias value f′(N) needed by the clipping function (e.g., clipping function 600 shown in FIG. 8) is fed into the clipping circuit 1004 via the multiplexer 1006, and the mean values mp′_{R}, mp′_{G}, mp′_{B} to be processed by the clipping function (e.g., clipping function 600 shown in FIG. 8) are fed into the clipping circuit 1004 via the multiplexer 1106. The final predictor PD_{MPPF} is generated by the clipping circuit 1004, and is output via the demultiplexer 1008.

In another exemplary design, the clipping circuit 1004 is used to deal with computation of the final predictor PD_{MPPF} of a coding block, and then is reused to deal with computation of the final predictor PD_{MPP} of the same coding block. When the coding mode is MPPF mode, the multiplexer 1106 is controlled to connect the input port N32 to the output port N33, the multiplexer 1006 is controlled to connect the input port N12 to the output port N13, and the demultiplexer 1008 is controlled to connect the input port N23 to the output port N22. Hence, the second bias value f′(N) needed by a lipping function (e.g., clipping function 600 shown in FIG. 8) is fed into the clipping circuit 1004 via the multiplexer 1006, and the mean values mp′_{R}, mp′_{G}, mp′_{B} to be processed by the clipping function (e.g., clipping function 600 shown in FIG. 8) are fed into the clipping circuit 1004 via the multiplexer 1106. The final predictor PD_{MPPF} is generated by the clipping circuit 1004, and is output via the demultiplexer 1008. When the coding mode is MPP mode, the multiplexer 1106 is controlled to connect the input port N31 to the output port N33, the multiplexer 1006 is controlled to connect the input port N11 to the output port N13, and the demultiplexer 1008 is controlled to connect the input port N23 to the output port N21. Hence, the first bias value f(QP) needed by the clipping function (e.g., clipping function 600 shown in FIG. 6) is fed into the clipping circuit 1004 via the multiplexer 1006, and the mean values MP′_{R}, MP′_{G}, MP′_{B} to be processed by the clipping function (e.g., clipping function 600 shown in FIG. 6) are fed into the clipping circuit 1004 via the multiplexer 1106. The final predictor PD_{MPP} is generated by the clipping circuit 1004, and is output via the demultiplexer 1008.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image encoding method for encoding an image, comprising:
performing a mean value calculation operation to calculate a mean value of each color channel of a plurality of reconstructed pixels;
determining a first predictor used by a first candidate coding mode of a current coding block according to a plurality of mean values of a plurality of color channels of the reconstructed pixels that are obtained by the mean value calculation operation, wherein the current coding block included in the image comprises a plurality of pixels;
determining a second predictor used by a second candidate coding mode of the current coding block according to the mean values of the color channels of the reconstructed pixels that are obtained by the same mean value calculation operation, wherein determining the first predictor and determining the second predictor are performed in a parallel manner;
determining a coding mode selected from a plurality of candidate coding modes of the current coding block, wherein the candidate coding modes comprise at least the first candidate coding mode and the second candidate coding mode; and
encoding the current coding block into a part of a bitstream according to at least the determined coding mode.

2. The image encoding method of claim 1, wherein:
the reconstructed pixels are generated from reconstructing a plurality of pixels of a previous coding block, where the previous coding block is a left coding block of the current coding block; or
the reconstructed pixels are generated from reconstructing a plurality of pixels located at a previous pixel line, where the previous pixel line is directly above an upper-most pixel line of the current coding block.

3. The image encoding method of claim 1, wherein determining the first predictor comprises:
generating the first predictor by applying a clipping function with a first bias value to the mean values of the color channels of the reconstructed pixels; and
determining the second predictor comprises:
generating the second predictor by applying the clipping function with a second bias value to the mean values of the color channels of the reconstructed pixels;
wherein the first bias value and the second bias value are derived from different data, respectively.

4. The image encoding method of claim 3, wherein the first bias value is derived from a quantization parameter of the current coding block, and the second bias value is derived from a bit depth of each pixel included in the current coding block.

5. The image encoding method of claim 3, wherein the first predictor is generated by a first clipping circuit that is configured to perform the clipping function with the first bias value during a first period, the second predictor is generated by a second clipping circuit that is configured to perform the clipping function with the second bias value during a second period overlapping the first period, and the first clipping circuit and the second clipping circuit are separate clipping circuits.

6. The image encoding method of claim 1, wherein one of the first candidate coding mode and the second candidate coding mode is a Video Electronics Standards Association (VESA) Advanced Display Stream Compression (A-DSC) midpoint prediction (MPP) mode, and another of the first candidate coding mode and the second candidate coding mode is a VESA A-DSC midpoint prediction fallback (MPPF) mode.

7. An image encoding method for encoding an image, comprising:
performing a mean value calculation operation to calculate a mean value of each color channel of a plurality of reconstructed pixels;
determining a first predictor used by a first candidate coding mode of a current coding block according to a plurality of mean values of a plurality of color channels of the reconstructed pixels that are obtained by the mean value calculation operation, wherein the current coding block included in the image comprises a plurality of pixels;
determining a second predictor used by a second candidate coding mode of the current coding block according to the mean values of the color channels of the reconstructed pixels that are obtained by the same mean value calculation operation, wherein determining the second predictor is started after determining the first predictor is completed;
determining a coding mode selected from a plurality of candidate coding modes of the current coding block, wherein the candidate coding modes comprise at least the first candidate coding mode and the second candidate coding mode; and
encoding the current coding block into a part of a bitstream according to at least the determined coding mode.

8. The image encoding method of claim 7, wherein:
the reconstructed pixels are generated from reconstructing a plurality of pixels of a previous coding block, where the previous coding block is a left coding block of the current coding block; or
the reconstructed pixels are generated from reconstructing a plurality of pixels located at a previous pixel line, where the previous pixel line is directly above an upper-most pixel line of the current coding block.

9. The image encoding method of claim 7, wherein determining the first predictor comprises:
generating the first predictor by applying a clipping function with a first bias value to the mean values of the color channels of the reconstructed pixels; and
determining the second predictor comprises:
generating the second predictor by applying the clipping function with a second bias value to the mean values of the color channels of the reconstructed pixels;
wherein the first bias value and the second bias value are derived from different data, respectively.

10. The image encoding method of claim 9, wherein the first bias value is derived from a quantization parameter of the current coding block, and the second bias value is derived from a bit depth of each pixel included in the current coding block.

11. The image encoding method of claim 9, wherein the first predictor is generated by a clipping circuit that is used to perform the clipping function with the first bias value during a first period, and the second predictor is generated by the clipping circuit that is reused to perform the clipping function with the second bias value during a second period not overlapping the first period.

12. The image encoding method of claim 7, wherein one of the first candidate coding mode and the second candidate coding mode is a Video Electronics Standards Association (VESA) Advanced Display Stream Compression (A-DSC) midpoint prediction (MPP) mode, and another of the first candidate coding mode and the second candidate coding mode is a VESA A-DSC midpoint prediction fallback (MPPF) mode.

13. An image encoding method for encoding an image, comprising:
performing a first mean value calculation operation to calculate a first mean value of each color channel of a plurality of first reconstructed pixels;
determining a first predictor used by a first candidate coding mode of a current coding block according to a plurality of first mean values of a plurality of color channels of the first reconstructed pixels that are obtained by the first mean value calculation operation, wherein the current coding block included in the image comprises a plurality of pixels;
performing a second mean value calculation operation to calculate a second mean value of each color channel of a plurality of second reconstructed pixels, wherein the second reconstructed pixels are same as or different from the first reconstructed pixels, and the first mean value calculation operation and the second mean value calculation operation are performed in a parallel manner;
determining a second predictor used by a second candidate coding mode of the current coding block according to a plurality of second mean values of a plurality of color channels of the second reconstructed pixels that are obtained by the second mean value calculation operation, wherein determining the second predictor is started after determining the first predictor is completed;
determining a coding mode selected from a plurality of candidate coding modes of the current coding block, wherein the candidate coding modes comprise at least the first candidate coding mode and the second candidate coding mode; and
encoding the current coding block into a part of a bitstream according to at least the determined coding mode.

14. The image encoding method of claim 13, wherein:
the first reconstructed pixels or the second reconstructed pixels are generated from reconstructing a plurality of pixels of a previous coding block, where the previous coding block is a left coding block of the current coding block; or
the first reconstructed pixels or the second reconstructed pixels are generated from reconstructing a plurality of pixels located at a previous pixel line, where the previous pixel line is directly above an upper-most pixel line of the current coding block.

15. The image encoding method of claim 13, wherein the first mean values of the color channels of the first reconstructed pixels are generated by a first mean value calculation circuit that is configured to perform the first mean value calculation operation during a first period, the second mean values of the color channels of the second reconstructed pixels are generated by a second mean value calculation circuit that is configured to perform the second mean value calculation operation during a second period overlapping the first period, and the first mean value calculation circuit and the second mean value calculation circuit are separate mean value calculation circuits.

16. The image encoding method of claim 13, wherein determining the first predictor comprises:
generating the first predictor by applying a clipping function with a first bias value to the first mean values of the color channels of the first reconstructed pixels; and
determining the second predictor comprises:
generating the second predictor by applying the clipping function with a second bias value to the second mean values of the color channels of the second reconstructed pixels;
wherein the first bias value and the second bias value are derived from different data, respectively.

17. The image encoding method of claim 16, wherein the first bias value is derived from a quantization parameter of the current coding block, and the second bias value is derived from a bit depth of each pixel included in the current coding block.

18. The image encoding method of claim 16, wherein the first predictor is generated by a clipping circuit that is used to perform the clipping function with the first bias value during a first period, and the second predictor is generated by the clipping circuit that is reused to perform the clipping function with the second bias value during a second period not overlapping the first period.

19. The image encoding method of claim 13, wherein one of the first candidate coding mode and the second candidate coding mode is a Video Electronics Standards Association (VESA) Advanced Display Stream Compression (A-DSC) midpoint prediction (MPP) mode, and another of the first candidate coding mode and the second candidate coding mode is a VESA A-DSC midpoint prediction fallback (MPPF) mode.

20. An image encoder for encoding an image, comprising:
a compression circuit, comprising:
a mean value calculation circuit, configured to perform a mean value calculation operation to calculate a mean value of each color channel of a plurality of reconstructed pixels;
a first clipping circuit, configured to generate a first predictor used by a first candidate coding mode of a current coding block by clipping a plurality of mean values of a plurality of color channels of the reconstructed pixels that are obtained by the mean value calculation operation, wherein the current coding block included in the image comprises a plurality of pixels; and
a second clipping circuit, configured to generate a second predictor used by a second candidate coding mode of the current coding block by clipping the mean values of the color channels of the reconstructed pixels that are obtained by the same mean value calculation operation, wherein the first clipping circuit and the second clipping circuit are separate clipping circuits; and
a mode decision circuit, configured to determine a coding mode selected from a plurality of candidate coding modes of the current coding block, wherein the candidate coding modes comprise at least the first candidate coding mode and the second candidate coding mode;
wherein the compression circuit is further configured to encode the current coding block into a part of a bitstream according to at least the determined coding mode.

21. An image encoder for encoding an image, comprising:
a compression circuit, comprising:
a mean value calculation circuit, configured to perform a mean value calculation operation to calculate a mean value of each color channel of a plurality of reconstructed pixels; and
a clipping circuit, wherein the clipping circuit is used to generate a first predictor used by a first candidate coding mode of a current coding block by clipping a plurality of mean values of a plurality of color channels of the reconstructed pixels that are obtained by the mean value calculation operation, and is reused to generate a second predictor used by a second candidate coding mode of the current coding block by clipping the mean values of the color channels of the reconstructed pixels that are obtained by the same mean value calculation operation, wherein the current coding block included in the image comprises a plurality of pixels; and
a mode decision circuit, configured to determine a coding mode selected from a plurality of candidate coding modes of the current coding block, wherein the candidate coding modes comprise at least the first candidate coding mode and the second candidate coding mode;
wherein the compression circuit is further configured to encode the current coding block into a part of a bitstream according to at least the determined coding mode.

22. An image encoder for encoding an image, comprising:
a compression circuit, comprising:
a first mean value calculation circuit, configured to perform a first mean value calculation operation to calculate a first mean value of each color channel of a plurality of first reconstructed pixels;
a second mean value calculation circuit, configured to perform a second mean value calculation operation to calculate a second mean value of each color channel of a plurality of second reconstructed pixels, wherein the second reconstructed pixels are same as or different from the first reconstructed pixels, and the first mean value calculation circuit and the second mean value calculation circuit are separate mean value calculation circuits; and
a clipping circuit, wherein the clipping circuit is used to generate a first predictor used by a first candidate coding mode of a current coding block by clipping a plurality of first mean values of a plurality of color channels of the first reconstructed pixels that are obtained by the first mean value calculation operation, and is reused to generate a second predictor used by a second candidate coding mode of the current coding block by clipping a plurality of second mean values of a plurality of color channels of the second reconstructed pixels that are obtained by the second mean value calculation operation, wherein the current coding block included in the image comprises a plurality of pixels; and
a mode decision circuit, configured to determine a coding mode selected from a plurality of candidate coding modes of the current coding block, wherein the candidate coding modes comprise at least the first candidate coding mode and the second candidate coding mode;
wherein the compression circuit is further configured to encode the current coding block into a part of a bitstream according to at least the determined coding mode.
